(19) United States
(12) Patent Application Publication
(10) Pub. No.: US 2020/0242520 A1
(43) Pub. Date: Jul. 30, 2020

(54) GENERATING A LIST OF AVAILABLE DATA ITEMS FROM AT LEAST ONE SERVICE PROVIDER

(71) Applicant: AMADEUS S.A.S., Biot (FR)

(72) Inventors: Marc Andre Jerome TRAINA, Tourrette-Levens (FR); Yoann POULAIN, Nice (FR); Charles Michel Pierre Guillaume CULTIEN, Nice (FR); Valerian Romain Emmanuel ROCHE, Cambridge, MA (US); Fabien Xavier MOURGUES, Roquefort-Les-Pins (FR); Gregory VALIGIANI, Cagnes-sur-mer (FR)

(21) Appl. No.: 16/747,996

(22) Filed: Jan. 21, 2020

(30) Foreign Application Priority Data
Jan. 25, 2019 (FR) 1900655

(51) Int. Cl. G06Q 10/02; G06Q 30/02; G06Q 50/12; G06F 16/23

(52) U.S. Cl. CPC G06Q 10/02; G06F 16/2365; G06Q 50/12; G06Q 30/0283

(57) ABSTRACT

A computer-implemented method comprising: receiving a user-generated request comprising functional data; retrieving a list of data items and a set of dependency rules, each data item being assigned an undefined binary validity value; generating a directed graph by organizing the data items in accordance with the retrieved dependency rules; applying a filtration process to solve the directed graph comprising: calculating the validity value; propagating the validity values through the graph; and filtering the directed graph by keeping only nodes having a validity value of one; calculating, for each filtered data item, a price; and generating a list of available data items with their price. The node suppression decreases the number of data items for which a price has to be calculated, thereby saving resources and/or decreasing the time needed to resolve the user request.

### CROSS-REFERENCE TO RELATED APPLICATION

This application claims priority to French patent application no. 1900655, filed Jan. 25, 2019, the contents of which is incorporated herein by reference.

### FIELD

The present invention relates to a computer-implemented method, computer system and computer program product for generating a list of available data items from at least one service provider in response to a user-generated request. Specifically, the present invention focusses on resolving a user request relating to hotel room reservations by interfacing with an inventory database from at least one hotel.

### BACKGROUND

In hotel reservation systems, a crucial feature is to be able to resolve an incoming user request in a timely fashion. A user request typically comprises functional data detailing one or more criteria that the user request needs to satisfy. The functional data may comprise user-related data and service-related data. User-related data is, for example, whether or not the user is handicapped, in which case he needs to be assigned a room suitable for his handicap. User-related data may also include the number of people and their age, for example two parents with their young infant may require a different type of room than those same parents with a teenager. User-related data may also relate to the purpose of the trip, i.e. business or holiday. Service-related data is typically related to the room type (e.g. low-floor, high-floor, quiet room, ocean-view, city-view, garden-view, smoking, non-smoking, single, double, triple, king-size bed, queen-size bed, executive room, suite, etc.). Service-related data typically also includes arrival and departures dates and may further include that multiple rooms are requested.

Besides the functional data in the user request, there are other complexities arising in resolving a user request. An important complexity is introduced by the hotel (chain) owner and relates to various rates that may be applicable to a same room. Specifically, hotel owners, especially for large scale hotel chains, have different rate plans. Examples of rate plans are: Best Flexible Rate (BFR) plan indicating the lowest and least restrictive publicly available rate for that room type at the time of reservation; Best Rate Guarantee (BRG) plan meaning that if you find a cheaper rate within a set period of time after reservation, the difference is compensated; low rate plan meaning the lowest publicly available rate for that room type at the time of reservation which reservation is then typically liable to cancellation fees; alternate rate plan which is only used when one or more other rate plans are not available; etc. The rate plans may also be dependent on the functional data in the user request (e.g. the user may include a request to only view BFRs).

Another complexity that has to be taken into account are the so-called business rules that are implemented by hotel chains. In general, these rules are implemented on the level of room stays. A room stay is a pairing of a room type and a room rate. The business rules detail that an availability of a certain room stay (or a group of room stays) is dependent on the availability of a different room stay (or a different group of room stays). In a first scenario, it may be that a rate plan is only shown as available when a different rate plan is no longer available. For example, a hotel has 20 rooms of room type A and promotes 10 of these at a reduced rate plan. Only when the pre-set number of rooms of room type A has been reserved does the normal rate plan become available. In a second scenario, it may be that a room type becomes available only when one or more other room types are no longer available. For example, when a non-handicapped person request a single room, it may be that he is offered a room type suited for a handicapped person as there are no single rooms available anymore.

In general, resolving the user request, requires to identify one or more room stays that satisfy the user request taking into account the dependency rules. However, a user normally also expects to receive a price for each available room. As such, even after having identified available room stays, another complexity in resolving the user request is the actual price calculation of the room stay. In order to calculate a price, hotel reservation systems are normally provided with a dedicated pricing engine to generate the price. In order to generate the price, the pricing engine needs to interface with other dedicated systems (e.g. a revenue management system). Details of the pricing engine are not important for the present invention, but it should be kept in mind that this typically requires a lot of resources and is therefore typically most time-consuming in resolving a user request.

It should be further pointed out that, at present, a method of resolving such a user request is handled by providing a dedicated computer system which includes hard-coded instructions for each possible dependency rule. As such, revising a specific dependency rule means having to revise the hard-coded instructions, which is very time-consuming and frequently leads to errors (e.g. forgetting to change the code for a certain type of user request in which case the old, outdated, dependency rule is still applied).

In view of the above described complexities, it is not straightforward to resolve user requests in a timely fashion. These examples show the need for improved systems, methods and computer program products for resolving user requests.

### SUMMARY

It is an object of the present invention to provide a computer-implemented method for resolving a user request using less resources.

This object is achieved according to the invention with a computer-implemented method for generating a list of available data items from at least one service provider in response to a user-generated request, the method comprising: a) receiving said user-generated request comprising functional data which includes user-related data and service-related data; b) retrieving, in particular from a first database, a list of data items, which list is preferably based on said functional data, each data item being assigned an undefined binary validity value; c) retrieving, from a rules database, a set of dependency rules for the validity value of the data items, which set is preferably based on said functional data; d) generating a directed graph by organizing said list of data items in accordance with the retrieved dependency rules, the directed graph comprising a plurality of nodes linked with arrows of a first type, each node representing a data item, each first type arrow extending from a tail node to a head node and representing that the validity value of said tail node is dependent on the validity value of said head node; e) applying a filtration process to solve said directed graph, which filtration process comprises a validity eliminating process comprising: val-i) calculating, for a first subset of nodes comprising at least one head node, the validity value according to a validity database, the validity value of a data item being equal to one when said at least one service provider comprises a service satisfying the service-related data in said user-generated request; val-ii) setting, after val-i), the validity value of each tail node that is dependent on a head node having a validity value of zero to zero or one; val-iii) repeating val-i) and val-ii) until each node in said directed graph has a set validity value; and val-iv) filtering, after val-iii), the directed graph by keeping only nodes having a validity value of one; f) calculating, by a pricing engine, for each filtered data item, a price; and g) generating said list of available data items by extracting filtered data items with their price from said directed graph.

The invention relies on the insight that reducing the number of data items for which a price has to be calculated will reduce the resources needed to resolve the user request in a timely manner. Consequently, based on the user request, in particular on the functional data therein, and the retrieved dependency rules, the data items are organised in a directed graph where each node represents a data item to which an undefined binary validity value is assigned. The directed graph is then filtered based on the validity value to reduce the number of nodes for which a price has to calculated. In particular, the validity elimination process starts with calculating the validity value for a first subset of nodes by interfacing with a validity database and afterwards propagating the calculated validity values throughout the directed graph based on the dependency rules. This process is iteratively applied until each node in said directed graph has a set validity value at which point the invalid nodes (i.e. nodes having a validity value of zero) are suppressed.

Although the rate of suppression (i.e. the number of data items suppressed relative to the original number of data items) depends on a great number of factors, it has been found that, on average, such a strategy decreases the number of data items for which a price has to be calculated. Consequently, less calls have to be made to the pricing engine in order to resolve the user request, thereby saving resources and/or decreasing the time needed to resolve the user request.

As a further advantage, the provision of a separate rules database comprising all dependency rules enables easy revision of one or more rules. In particular, when a dependency rule has to be revised, it now suffices to only revise the rule in the database since the directed graph is generated for each user request. This saves time when revising dependency rules when compared to hard-coded dependency rules and also reduces the risk of errors in such revisions.

In an embodiment of the present invention, said directed graph comprises one or more leaves, a leaf being a head node which is not a tail node, wherein, for val-i), said first subset of nodes consists of leaves.

Ensuring that the first subset of nodes consists of leaves optimally benefits from the dependency rules. In particular, this avoids calculating a validity value of a dependent node in val-i) which, as it turns out later, is invalid due to its dependency on a node that was calculated (or set) at that later time.

In an embodiment of the present invention, the method further comprises filtering, between f) and g), the directed graph by keeping only nodes having a price above a predefined threshold.

In this embodiment, possible revenues for the service provider are improved by suppressing low-revenue data items.

In an embodiment of the present invention, each node is assigned an undefined binary visibility value, wherein c) further comprises retrieving, from the rules database, a set of visibility value dependency rules, which set is preferably based on said functional data, wherein d) further comprises: d-i) adding arrows of a second type between the nodes in accordance with the retrieved visibility value dependency rules, each second type arrow extending from a tail node to a head node and representing that the visibility of said tail node is dependent on the visibility of said head node, wherein e) further comprises a visibility eliminating process comprising: vis-i) setting the visibility value of each node that has validity value of zero to zero; vis-ii) defining, for a second subset of nodes comprising at least one head node, the visibility value according to a visibility database, the visibility value of a data item being equal to one when the service associated with said data item satisfies the user-related data in said user-generated request; vis-iii) setting, after vis-ii), the visibility value of each tail node that is dependent on a head node having a visibility value of zero as zero or one; vis-iv) repeating vis-ii) and vis-iii) until each node in said directed graph has a set visibility value; and vis-v) filtering, after vis-iv), the directed graph by keeping only nodes having a visibility value of one.

This embodiment includes a secondary elimination process based on a visibility value. The visibility value indicates whether or not a data item is visible to the user, preferably based on the functional data, in particular the user-related data contained therein. Although the rate of suppression (i.e. the number of data items suppressed relative to the original number of data items) depends on a great number of factors, it has been found that including a second elimination process, on average, further decreases the number of data items for which a price has to be calculated. Consequently, less calls have to be made to the pricing engine in order to resolve the user request, thereby saving resources and/or decreasing the time needed to resolve the user request.

In a preferred embodiment of the present invention, the second subset of nodes is included the first subset of nodes, wherein, preferably, the first subset of nodes includes nodes with a visibility equal to zero.

This ensures that calls made to the visibility database are done for at least the same data items for which calls were done to the validity database, meaning that the calls may be executed simultaneously to save time and/or resources.

In an embodiment of the present invention, each node is assigned an integer counter value, the counter value of a node being the number of tail nodes that depend on said node via first type arrows, wherein, for the validity eliminating process, nodes having the highest counter values are considered first.

This embodiment further optimizes the filtration process by starting with nodes having the highest number of dependent nodes as these, especially when they turn out to be invalid and, optionally, invisible, suppress the most dependent nodes.

In an embodiment of the present invention, said directed graph comprises at least one of the following: at least one tail node that is dependent on multiple head nodes; and multiple tail nodes that are dependent on a single head node.

In an embodiment of the present invention, said arrows represent at least one of the following dependency relations: “TRUE” indicating that the validity value of a tail node is the same as the validity value of a head node; “FALSE” indicating that the validity value of a tail node is the opposite of the validity value of a head node; “AND” indicating that the validity value of a tail node is one when the validity value of all its head nodes are one; and “OR” indicating that the validity value of a tail node is one when the validity value of at least one of its head nodes is one.

In an embodiment of the present invention, each first type arrow is TRUE and each second type arrow is FALSE.

Based on the above dependency relations and multiple dependencies, each conceivable dependency rule may be implemented only with a limited number of operators.

In an embodiment of the present invention, each data item is a room stay, said service provider being at least one hotel, said service-related data comprising at least an arrival date and a departure date and said validity database being an inventory of said at least one hotel, wherein said visibility database is a look up table of said at least one hotel, wherein a node has a visibility value of one when the type of the room stay satisfies the user-related data in said user-generated request, wherein each room stay comprises a room type and a room rate, a node having a validity value of one when said at least one hotel comprises a room corresponding to the type of the room stay that is free between said arrival date and said departure date.

In this embodiment, the method is especially suited for a computerized hotel reservation system.

In a preferred embodiment of the present invention, said user-generated request comprises a natural number greater than zero indicating the requested number of rooms, wherein a node has validity value of one when said at least one hotel comprises the requested number of rooms corresponding to the type of the room stay that is free between said arrival date and said departure date.

This check avoids having to call to the pricing engine when the number of available room stays is already below the request number, which greatly speeds up resolving the request.

This object is also achieved by a computer system comprising means configured to perform the method steps as described above.

This object is further achieved by a computer program product comprising instructions stored on a computer readable medium which, when the program is executed by a computer, cause the computer to carry out the method steps as described above.

### BRIEF DESCRIPTIONS OF THE DRAWINGS

The invention will be further explained by means of the following description and the appended figures.

FIG. 1 shows a flow-chart of a computer-implemented method for resolving a user request for a hotel reservation according to an embodiment of the present invention.

FIG. 2 shows a computerized hotel reservation system according to an embodiment of the present invention.

FIG. 3 shows an example of directed graphs.

FIG. 4 shows another example of directed graphs.

FIG. 5 shows a flow-chart of the filtering of FIG. 1.

### DETAILED DESCRIPTION

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description are used for descriptive purposes. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

In general, the routines executed to implement embodiments of the present invention, whether implemented as part of an operating system or a specific application, component, program, object, module or sequence of instructions, or even a subset thereof, may be referred to herein as “computer program code” or simply “program code”. Program code typically comprises computer readable instructions which are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM) or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g. radio waves or other propagating electromagnetic waves). Computer readable program instructions may be downloaded to a computer, another type of programmable data processing apparatus or another device from a computer readable storage medium or to an external computer or external storage device via a network.

Computer readable program instructions stored in a computer readable medium may be used to direct a computer, other types of programmable data processing apparatus or other devices to function in a particular manner, such that the instructions stored in the computer readable medium produce an article of manufacture including instructions that implement the functions, acts and/or operations specified in the flowcharts, sequence diagrams and/or block diagrams. The computer program instructions may be provided to one or more processors of a general-purpose computer, a special purpose computer or other programmable data processing apparatus to produce a machine, such that the instructions, which execute via the one or more processors, cause a series of computations to be performed to implement the functions, acts and/or operations specified in the flowcharts, sequence diagrams and/or block diagrams.

In certain alternative embodiments, the functions, acts and/or operations specified in the flowcharts, sequence diagrams and/or block diagrams may be re-ordered, processed serially and/or processed concurrently consistent with embodiments of the invention. Moreover, any of the flowcharts, sequence diagrams and/or block diagrams may include more or fewer blocks than those illustrated consistent with embodiments of the invention.

Although the present disclosure will be described with reference to a hotel reservation system, it will be readily appreciated that the invention is not limited to this particular application and should be considered as applicable in any kind of data system directed to resolving user requests where the desired data items are related to one another through dependency rules.

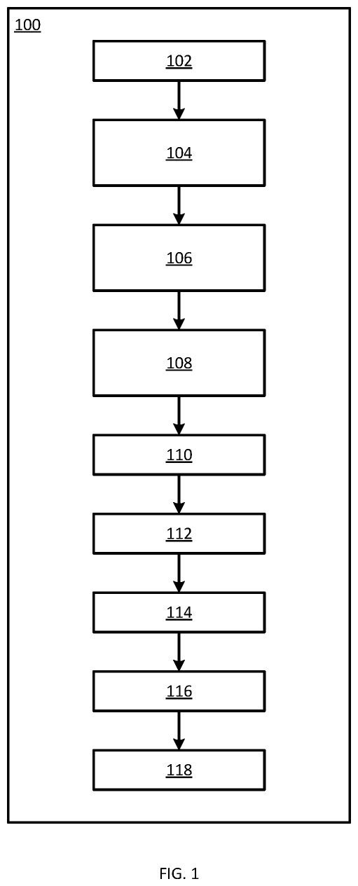

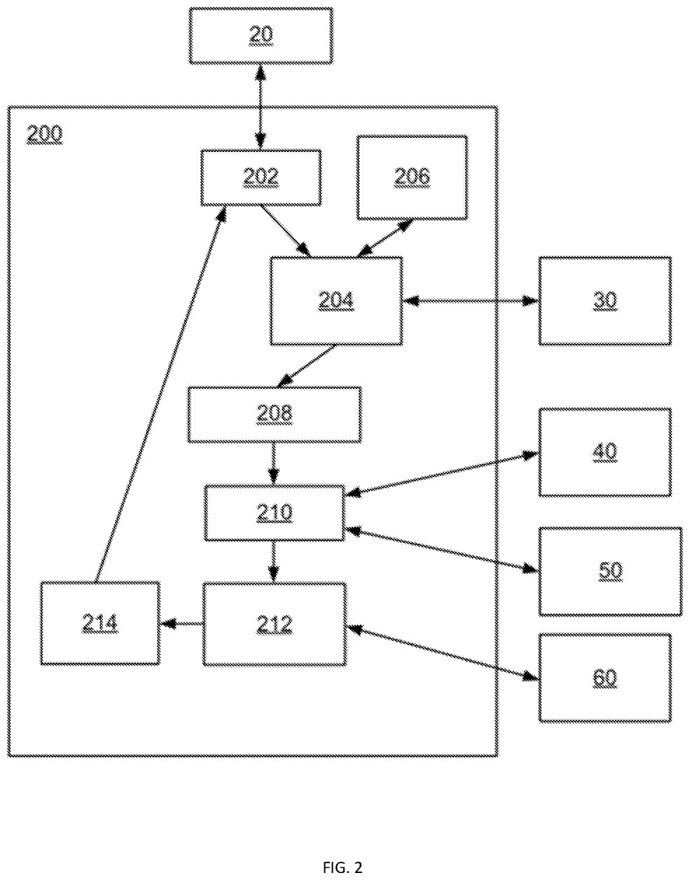

The invention will generally be described with reference to FIGS. 1 and 2 where a method 100 and system 200 are shown for resolving an incoming hotel reservation request.

The end user (e.g. a travel planner, a customer, etc.) generates a request at his user terminal 20 (e.g. a personal computer, a mobile device including a smartphone, laptop, PDA, etc.). This request may be automatically generated by dedicated software (e.g. a hotel chain website or a travel planning website) enabling the user to input a list of pre-set parameters (e.g. destination, arrival and departures dates, number of people, preferences such as room type, room location, parking availability, etc.). The user-generated request comprises functional data which includes user-related data and service-related data. User-related data is, for example, whether or not the user is handicapped and may also include the number of people and their age. User-related data may also relate to the purpose of the trip. Service-related data is typically related to the room type and also includes arrival and departures dates and may further include that multiple rooms are requested.

The user-generated request is sent from the user terminal 20 to the computer system 200. This sending may occur via many different routes, but is typically done via the Internet. The request is received in 102 in the Input-Output (10) module 202 which is responsible for handling all incoming and outgoing correspondence between the system 200 and the user terminal 20.

After receiving the request, the functional data in the request is sent to a data retrieval module 204 which has the task of processing the functional data in 104 such that a list of room stays and a set of validity dependency rules may be retrieved in 106 and 108 respectively. Specifically, the data analysis module 204 may process and/or format the functional data or a subset thereof into a suitable data structure for interfacing with an external hotel room inventory 30 and with a dependency rules database 206. Moreover, the data analysis module 204 may automatically initiate one or more calls to the external hotel room inventory 30 and the dependency rules database 206 in order to retrieve the desired data. In some embodiments, concurrent with the validity dependency rules, a set of visibility dependency rules is also retrieved in 108.

In general, a room stay may be considered as a pair consisting of a room type and a room rate. Examples of room types are single, double, triple, executive room, suite, low-floor, high-floor, quiet room, ocean-view, city-view, garden-view, smoking, non-smoking, king-size bed, queen-size bed, handicapped, etc. Examples of room rates are Best Flexible Rate (BFR), Best Rate Guarantee (BRG), low rate, alternate rate, etc. It will be readily appreciated that the same physical hotel room may be present in multiple room stays. For example, a double room may be paired with four different rates, in which case the same physical room generates four different room stays.

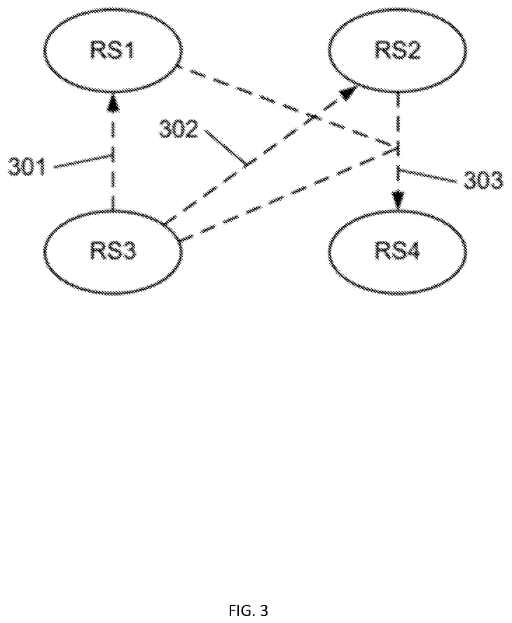

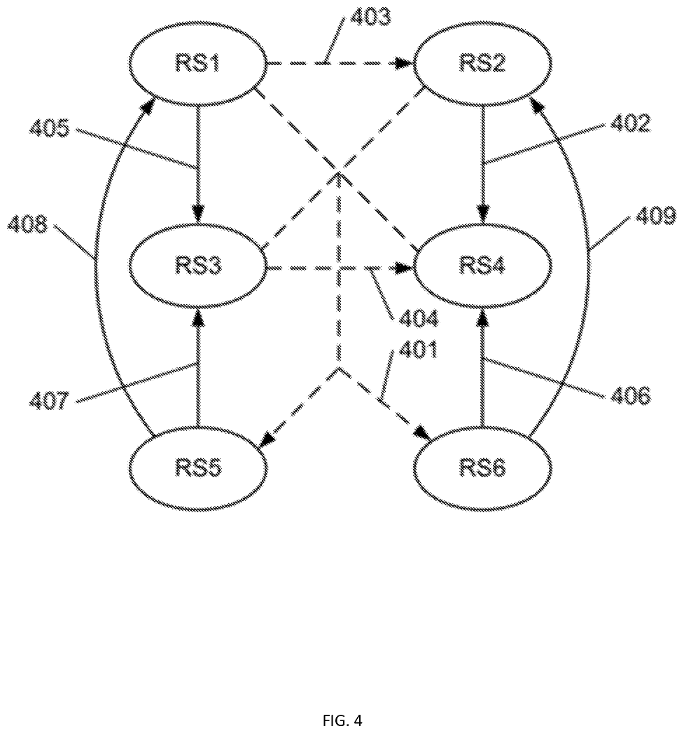

The retrieved data (i.e. the list of room stays, the set of validity dependency rules and, optionally, the set of visibility dependency rules) is sent to a graph generator 208 which is responsible for organizing the list of room stays in a directed graph based on the dependency rules in 110. In the graph generator 208 one or, optionally, two binary values will be assigned to each room stay, a first value indicating the validity value of the room stay and a second value indicating the visibility of the room stay. The validity value is related to whether or not the hotel (chain) has a room available of the indicated room type. The visibility value is related to whether or not a room stay may be offered to a user. For example, a handicapped room, although available, should not, in a first instance, be shown to a non-handicapped person. In general, both values are also related to one another as the visibility value is always set to zero when the validity value is zero as described in more detail below. A few examples of a directed graph will be described with reference to FIGS. 3 and 4.

FIG. 3 illustrates a situation with four room stays each having the same room rate and a single person is making a reservation. Room stay 1 (RS1) and room stay 2 (RS2) represent a double room, room stay 3 (RS3) represents a single room and room stay 4 (RS4) represents a room for a handicapped person. Since RS1 and RS2 are identical, they are independent from one another. Both RS1 and RS2 are dependent on the visibility of RS3 as a double room will only be offered in case no single room is available. In other words, when RS3 has a visibility value of 1 (i.e. is visible), then RS1 and RS2 have a visibility value of 0 (i.e. are invisible). As such, arrows 301 and 302 indicate a “FALSE” visibility relationship. RS4 is dependent on the visibility of RS1, RS2 and RS3 as this room stay may be offered to a non-handicapped person only if RS1, RS2 and RS3 are not visible, meaning that arrow 303 indicates a “FALSE-AND” visibility relationship. In other words, when RS1, RS2 and RS3 have a visibility value of 0, then RS4 has a visibility value of 1.

In the directed graph of FIG. 3 the following may now occur. Assume that the user indicates that he is travelling alone, then RS3 will be visible under the assumption that it is valid, otherwise it will be invisible. If RS3 is valid, then only RS3 will be output in 112 since RS1, RS2 and RS3 are invisible. If RS3 is invalid, then RS1 and RS2 will be put as visible. Whether or not RS1 and/or RS2 will now be output depends solely on the validity of RS1 and RS2. In case either one is valid, then that one will be output. In case neither one is valid, only then will RS4 be visible. RS4 will then be output depending on its validity.

FIG. 4 illustrates a situation with six room stays denoting double rooms, each with three different rate plans. RS1, RS3 and RS5 indicate a double room with respective ones of main rate, alternate rate and BFR. Similarly, RS2, RS4 and RS6 indicate a double room with respective ones of main rate, alternate rate and BFR. Due to hotel policy, BFR is always invisible, unless all other rates are no longer valid and therefore invisible. As such, RS5 and RS6 depend on the visibility of RS1 to RS4. Moreover, in case the BFR room stays (RS5 and RS6) are not valid, this means that the physical rooms have normally been booked, then none of RS1 to RS4 may be valid. As such, the validity of RS1 to RS4 is dependent directly on the validity of RS5 and RS6 as indicated with arrows 406 to 409. The alternate rate is only valid in case both main rates are invalid. As such, RS3 and RS4 depend on the validity of RS1 and RS2. Moreover, the user indicated preference of a quiet room. In this case, RS1 is a quiet room, while RS2 is not. Consequently, the visibility of RS2 is dependent on the visibility of RS1. In summary, arrow 401 indicates a “FALSE-AND” visibility relationship, arrow 402 indicates a “FALSE-AND” validity relationship, arrows 403 and 404 indicate a “FALSE” visibility relationship, arrow 405 indicates a “FALSE” validity relationship and arrows 406 to 409 indicate a “TRUE” validity relationship.

In the directed graph of FIG. 4 the following may now occur. RS5 or RS6 is valid, which automatically makes RS1 and RS3 or RS2 and RS4 as valid. RS1 will be output in 112. In case RS5 is not valid, then RS1 will be invisible and the user will be presented with RS2. If RS2 is also invalid, RS3 will be output. When RS1 to RS3 are invalid, RS4 will be output assuming it is valid. In case RS4 is not valid, RS5 and RS6 will be output.

It will be appreciated that the examples described above with reference to FIGS. 3 and 4 are highly simplified. In practice, the directed graph may, depending on the hotel (chain), easily comprise dozens and even hundreds of nodes, each node representing a room stay.

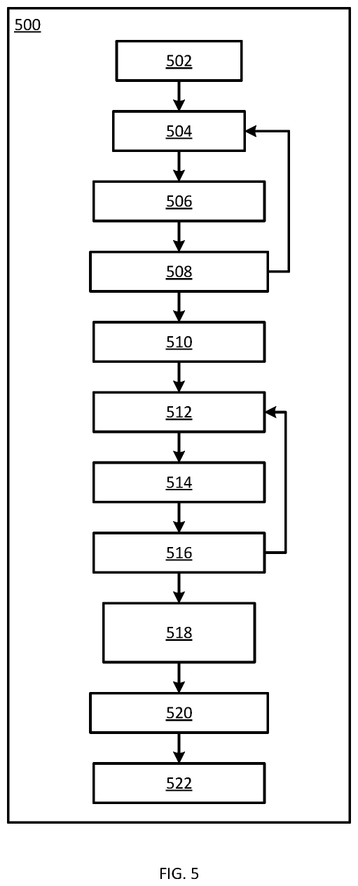

The end result of the graph generator 208 in 110 is a directed graph comprising a plurality of nodes (each node representing a room stay) that are connected with first type arrows and second type arrows indicating respectively validity dependency and visibility dependency between head nodes and tail nodes. This graph is sent to a filter module 210 that will apply a filtration process to solve said directed graph in 112, which filtration process 500 will be described with reference to FIG. 5.

In 502, the directed graph is received in the filter module 210. A subset of nodes is selected in 504 with which the filtration process will begin. Preferably, this subset consists of leaf nodes, i.e. nodes that are not dependent on other nodes to avoid having to calculate a visibility value in 506 that could have been determined from its head node. More preferably, this subset contains the leaf nodes with the highest number of dependent nodes. Advantageously, this subset is chosen to contain as few nodes as possible to minimize the number of visibility value calculations. For this subset, a visibility value is calculated in 506 by interfacing with a hotel room type look up table 50. This table 50 contains information on what room types may and may not be visible to certain user profiles.

Once the visibility value has been calculated for the subset, these values are propagated throughout the directed graph in accordance with the visibility dependency rules in 508. In case the propagation would not result in setting the visibility value of all nodes in the directed graph, 504 to 508 are repeated. In particular, a new subset is chosen containing unset nodes and the look up table 50 is again used to set the visibility value of these nodes, which visibility values are then propagated. Ultimately, each node in the directed graph will have a set visibility value.

A first suppression (or elimination) is done in 510. Specifically, each invisible tail node which is itself not a head node is suppressed. The fact that the node may not be a head node is to avoid suppressing nodes that may influence the validity elimination process that occurs subsequently. It will be appreciated that 510 may be skipped. Moreover, in case no visibility value was assigned in 110, 504 to 510 are also skipped.

In 512 a new subset of nodes is selected to begin the validity elimination process. Preferably, this subset consists of leaf nodes, i.e. nodes that are not dependent on another nodes to avoid having to calculate a validity value in 514 that could have been determined from its head node. More preferably, this subset contains the leaf nodes with the highest number of dependent nodes. Advantageously, this subset is chosen to contain as few nodes as possible to minimize the number of validity value calculations. In an embodiment, this subset is identical to the one selected in 504. For this subset, a validity value is calculated in 514 by interfacing with a hotel room availability engine 40. This engine 40 determines whether or not a room stay is available. Further details on the hotel room availability engine 40 will be avoided as this is a very complex engine that interfaces with a plurality of different external systems to generate up-to-date availabilities. However, it will be appreciated that calls to the hotel room availability engine 40 require a significant amount of resources more than calls to the hotel room type look up table 50 and it is therefore beneficial to minimize the number of calls if possible. This is also why 510 is beneficial as it may reduce the number of calls to the hotel room availability engine 40.

Once the validity value has been calculated for the subset, these values are propagated throughout the directed graph in accordance with the validity dependency rules in 516. In case the propagation would not result in setting the validity value of all nodes in the directed graph, 512 to 516 are repeated. In particular, a new subset is chosen containing unset nodes and the hotel room availability engine 40 is again called to calculate the validity value of these nodes, which validity values are then propagated. Ultimately, each node in the directed graph will have a set validity value.

In 518, the visibility values are adjusted where necessary based on the validity values. Specifically, invalid nodes are set to a visibility value of zero. The changed visibility values are then propagated in 520. 518 and 520 may also be skipped and will be skipped in case that no visibility values were set in 110. A second suppression is done in 522 by keeping only nodes having a validity value, and optionally a visibility value, of one.

Once the directed graph has been filtered in 112, the price retrieval module 212 interfaces with an external pricing engine 60 to determine a price for each unsuppressed node in 114. As described above, details of the pricing engine are not important for the present invention, but it should be kept in mind that this typically requires a lot of resources and is therefore typically most time-consuming in resolving a user request and it is therefore beneficial to minimize the number of calls if possible.

Once the price has been retrieved for each remaining node, an additional filter may be applied in 116 by a price filter module 214. Specifically, it is checked whether the price of a node exceeds a pre-set threshold. For example, the threshold may be based on a low rate plan and require that the price is at least 15% above the price of the low rate plan. Nodes having too low a price are also suppressed.

The remaining nodes are provided to the 10 module 202 which lists them and outputs them in 118 to the user terminal 20.

Although aspects of the present disclosure have been described with respect to specific embodiments, it will be readily appreciated that these aspects may be implemented in other forms within the scope of the invention.

1. A computer-implemented method for generating a list of available data items from at least one service provider in response to a user-generated request, the method comprising:
a) receiving said user-generated request comprising functional data which includes user-related data and service-related data;
b) retrieving a list of data items, each data item being assigned an undefined binary validity value;
c) retrieving, from a rules database, a set of dependency rules for the validity value of the data items;
d) generating a directed graph by organizing said list of data items in accordance with the retrieved dependency rules, the directed graph comprising a plurality of nodes linked with arrows of a first type, each node representing a data item, each first type arrow extending from a tail node to a head node and representing that the validity value of said tail node is dependent on the validity value of said head node;
e) applying a filtration process to solve said directed graph, which filtration process comprises a validity eliminating process comprising:
val-i) calculating, for a first subset of nodes comprising at least one head node, the validity value according to a validity database, the validity value of a data item being equal to one when said at least one service provider comprises a service satisfying the service-related data in said user-generated request;
val-ii) setting, after val-i), the validity value of each tail node that is dependent on a head node having a validity value of zero to one or zero;
val-iii) repeating val-i) and val-ii) until each node in said directed graph has a set validity value; and
val-iv) filtering, after val-iii), the directed graph by keeping only nodes having a validity value of one;
f) calculating, by a pricing engine, for each filtered data item, a price; and
g) generating said list of available data items by extracting filtered data items with their price from said directed graph.

2. Method according to claim 1, wherein said directed graph comprises one or more leaves, a leaf being a head node which is not a tail node, wherein, for val-i), said first subset of nodes consists of leaves.

3. Method according to claim 1, wherein the method further comprises filtering, between f) and g), the directed graph by keeping only nodes having a price above a predefined threshold.

4. Method according to claim 1, wherein each node is assigned an undefined binary visibility value,
wherein c) further comprises retrieving, from the rules database, a set of visibility value dependency rules, wherein d) further comprises:
d-i) adding arrows of a second type between the nodes in accordance with the retrieved visibility value dependency rules, each second type arrow extending from a tail node to a head node and representing that the visibility of said tail node is dependent on the visibility of said head node,
wherein e) further comprises a visibility eliminating process comprising:
vis-i) setting the visibility value of each node that has validity value of zero to zero;
vis-ii) defining, for a second subset of nodes comprising at least one head node, the visibility value according to a visibility database, the visibility value of a data item being equal to one when the service associated with said data item satisfies the user-related data in said user-generated request;
vis-iii) setting, after vis-ii), the visibility value of each tail node that is dependent on a head node having a visibility value of zero as zero or one;
vis-iv) repeating vis-ii) and vis-iii) until each node in said directed graph has a set visibility value; and
vis-v) filtering, after vis-iv), the directed graph by keeping only nodes having a visibility value of one.

5. Method according to claim 4, wherein the second subset of nodes is included in the first subset of nodes, wherein, preferably, the first subset of nodes includes nodes with a visibility equal to zero.

6. Method according to claim 1, wherein each node is assigned an integer counter value, the counter value of a node being the number of tail nodes that depend on said node via first type arrows, wherein, for the validity eliminating process, nodes having the highest counter values are considered first.

7. Method according to claim 1, wherein said directed graph comprises at least one of the following:
at least one tail node that is dependent on multiple head nodes; and
multiple tail nodes that are dependent on a single head node.

8. Method according to claim 1, wherein said arrows represent at least one of the following dependency relations:
“TRUE” indicating that the validity value of a tail node is the same as the validity value of a head node;
“FALSE” indicating that the validity value of a tail node is the opposite of the validity value of a head node;
“AND” indicating that the validity value of a tail node is one when the validity value of all its head nodes are one; and
“OR” indicating that the validity value of a tail node is one when the validity value of at least one of its head nodes is one.

9. Method according to claim 8 when dependent on at least claim 4, wherein each first type arrow is TRUE and each second type arrow is FALSE.

10. Method according to claim 1, wherein each data item is a room stay, said service provider being at least one hotel, said service-related data comprising at least an arrival date and a departure date and said validity database being an inventory of said at least one hotel.

11. Method according to claim 10 when at least dependent on claim 4, wherein said visibility database is a look up table of said at least one hotel, wherein a node preferably has a visibility value of one when the type of the room stay satisfies the user-related data in said user-generated request.

12. Method according to claim 10, wherein each room stay comprises a room type and a room rate, a node having a validity value of one when said at least one hotel comprises a room corresponding to the type of the room stay that is free between said arrival date and said departure date.

13. Method according to claim 10, wherein said user-generated request comprises a natural number greater than zero indicating the requested number of rooms, wherein a node has validity value of one when said at least one hotel comprises the requested number of rooms corresponding to the type of the room stay that is free between said arrival date and said departure date.

14. A computer system for generate a list of available data items from at least one service provider in response to a user-generated request, the computer system comprising:
an input-output module to receive said user-generated request comprising functional data which includes user-related data and service-related data;
a data retrieval module to:
retrieve a list of data items, each data item being assigned an undefined binary validity value; and
retrieve, from a rules database, a set of dependency rules for the validity value of the data items;
a graph generator to generate a directed graph by organizing said list of data items in accordance with the retrieved dependency rules, the directed graph comprising a plurality of nodes linked with arrows of a first type, each node representing a data item, each first type arrow extending from a tail node to a head node and representing that the validity value of said tail node is dependent on the validity value of said head node;
a filter module to apply a filtration process to solve said directed graph, which filtration process comprises a validity eliminating process to:
val-i) calculate, for a first subset of nodes comprising at least one head node, the validity value according to a validity database, the validity value of a data item being equal to one when said at least one service provider comprises a service satisfying the service-related data in said user-generated request;
val-ii) set, after val-i), the validity value of each tail node that is dependent on a head node having a validity value of zero to one or zero;
val-iii) repeat val-i) and val-ii) until each node in said directed graph has a set validity value; and
val-iv) filter, after val-iii), the directed graph by keeping only nodes having a validity value of one;
a price retrieval module to calculate, via communication with a pricing engine, for each filtered data item, a price; and
a price filter module to generate said list of available data items by extracting filtered data items with their price from said directed graph.

15. A computer program product comprising program instructions stored on a computer readable medium executable by a computer system to generate a list of available data items from at least one service provider in response to a user-generated request, execution of the program instructions configuring the computer system to:
a) receive said user-generated request comprising functional data which includes user-related data and service-related data;
b) retrieve a list of data items, each data item being assigned an undefined binary validity value;
c) retrieve, from a rules database, a set of dependency rules for the validity value of the data items;
d) generate a directed graph by organizing said list of data items in accordance with the retrieved dependency rules, the directed graph comprising a plurality of nodes linked with arrows of a first type, each node representing a data item, each first type arrow extending from a tail node to a head node and representing that the validity value of said tail node is dependent on the validity value of said head node;
e) apply a filtration process to solve said directed graph, which filtration process comprises a validity eliminating process to:
val-i) calculate, for a first subset of nodes comprising at least one head node, the validity value according to a validity database, the validity value of a data item being equal to one when said at least one service provider comprises a service satisfying the service-related data in said user-generated request;
val-ii) set, after val-i), the validity value of each tail node that is dependent on a head node having a validity value of zero to one or zero;
val-iii) repeat val-i) and val-ii) until each node in said directed graph has a set validity value; and
val-iv) filter, after val-iii), the directed graph by keeping only nodes having a validity value of one;
f) calculate, by a pricing engine, for each filtered data item, a price; and
g) generate said list of available data items by extracting filtered data items with their price from said directed graph.
